(19) United States
(12) Patent Application Publication
(10) Pub. No.: US 2026/0065641 A1
(43) Pub. Date: Mar. 5, 2026

(54) Dynamic Refinement of Custom Classes Using Zero-Shot Image Classifiers

(71) Applicants: Nissan North America, Inc., Franklin, TN (US); The University of Massachusetts, Boston, MA (US)

(72) Inventors: Erik Lee St. Gray, Tacoma, WA (US); Takehito Teraguchi, Ebina (JP); Stefan Witwicki, San Carlos, CA (US); Shlomo Zilberstein, Amherst, MA (US); Marcell Jose Vazquez-Chanlatte, Palo Alto, CA (US); Saaduddin Mahmud, Amhurst, MA (US)

(21) Appl. No.: 18/821,352

(22) Filed: Aug. 30, 2024

(51) Int. Cl. G06V 10/764; G06F 3/01; G06V 10/24; G06V 10/25; G06V 10/74; G06V 20/58; G06V 40/16; G10L 15/18; G10L 15/22; G10L 25/63

(52) U.S. Cl. CPC G06V 10/764; G06F 3/013; G06V 10/248; G06V 10/25; G06V 10/761; G06V 20/58; G06V 40/176; G10L 15/1807; G10L 15/1815; G10L 15/22; G10L 25/63

(57) ABSTRACT

System and method for dynamically refining custom classes using zero-shot image classifiers. The system uses a CLIP model to generate text embeddings of object descriptions and image embeddings of captured images, and determines similarity scores between the text and image embeddings. When a similarity score exceeds a threshold, the system notifies a user that a captured image includes the object, and the system stores the relevant text prompt and captured image as a custom class. The system updates the custom class based on subsequent user feedback, which may comprise speech, facial expression, and physical action,

### TECHNICAL FIELD

This disclosure relates generally to establishing and refining custom classes using zero-shot image classifiers based on cumulative user prompts, and more specifically, to providing notifications to users about objects identified in real-time captured images that correlate with the objects indicated by user prompts according to Contrastive Language-Image Pre-training (CLIP).

### BACKGROUND

Some machine-learning applications are well suited for custom-trained models, such as plant species identification (trained on databases of images of plant life) or medical imaging analysis (trained on databases of medical images and diagnoses). However, custom training may not be practical or possible for some machine-learning applications, such as identifying objects or events in an environment, especially in an outdoor environment where the objects or events are effectively unconstrained. Zero-shot classifiers can therefore be used by these machine-learning applications to improve their performance and/or accuracy.

Zero-shot classifiers are machine learning models designed to identify and classify data points into categories that they have not encountered during the training phase. Unlike traditional classifiers that rely on extensive labeled datasets for each category, zero-shot classifiers leverage additional semantic information, such as textual descriptions or attributes, to recognize new classes. This is typically achieved by embedding both the input data (e.g., images) and the semantic information (e.g., user prompts) into a shared representation space. When presented with a new class, the model can classify data points by matching the input data to the semantic information, enabling it to perform classification without direct training on that specific class.

CLIP is a machine-learning model that learns to associate images with textual descriptions by embedding both into a shared representation space, e.g., “embeddings,” using a contrastive learning approach. This enables CLIP to perform zero-shot classification, allowing it to recognize and classify images based on natural language descriptions of categories it has not explicitly been trained on. During training, CLIP learns to associate images with corresponding textual descriptions by maximizing a similarity between matching image-text pairs and minimizing the similarity between non-matching pairs. This allows CLIP to understand and classify images based on text descriptions, even for classes it has not seen before. Consequently, CLIP can perform zero-shot classification by leveraging its learned embeddings to match new images with relevant textual descriptions, making it highly versatile and effective for various tasks without requiring extensive labeled datasets for every possible class. The similarity function, e.g., cosine similarity, may comprise a dot product between respective embeddings. A range of raw cosine similarity scores may be from −1 to 1. In some implementations, the raw cosine scores may be normalized to a range more suitable for subsequent computations, rankings, or comparisons, such as a range from 0 to 1.

In the context of CLIP, a class refers to a distinct group or label that the model can use to describe or classify images, such as “cat,” “dog,” and “bird.” Similarly, a category refers to a broad group or type of items that share common characteristics, such as “fiction,” “non-fiction,” and “science fiction.” As used herein, the term “class” encompasses the narrower meaning of class and/or the broader meaning of category, and the term “classify” (and variations thereof) encompasses classification (e.g., assigning a class) and/or categorization (e.g., assigning a category).

A more thorough treatment of CLIP can be found in the publication: Radford, et al. (2021), Learning Transferable Visual Models From Natural Language Supervision, In Proceedings of the 38th International Conference on Machine Learning (ICML 2021), arXiv: 2103.00020.

### SUMMARY

This disclosure focuses on systems and methods that use zero-shot classifiers for identifying objects or events that are outside of a vehicle on behalf of one or more occupants (e.g., a driver or one or more passengers) within the vehicle, and establishing and refining custom classes based on cumulative input provided by the occupants. For example, a driver of the vehicle can ask the system to provide a notification if and/or when the system identifies a certain object or event outside of the vehicle, such as a street sign with a specified street name, a Mexican-food restaurant, or a jaywalker crossing the street. The system can notify the driver when a presumed match occurs, and the driver can provide a response that can be used by the system to establish or refine a custom class. This disclosure is, however, broadly applicable to other applications, fields, and domains, such as agriculture, healthcare, entertainment, security, finance, engineering, and so on.

Specifically, disclosed herein are aspects, features, elements, implementations, and embodiments of a method, a system, and a non-transitory computer-readable medium for dynamic refinement of custom classes using zero-shot image classifiers.

A first aspect of the disclosed implementations is a method that includes the steps of: capturing images of an environment in real-time using an image-capturing device; generating image embeddings of the captured images using a trained Contrastive Language-Image Pre-training (CLIP) model; receiving a text prompt from a user indicating a first object or event; generating a text embedding of the text prompt using the CLIP model; computing similarity scores between the text embedding and the image embeddings; determining a highest similarity score of the similarity scores; determining that the highest similarity score exceeds a predefined threshold; identifying, in the respective captured image that corresponds to the highest similarity score, a second object or event that correlates with the first object or event; storing the text prompt and the respective captured image as a custom class for future use by the CLIP model; providing an indication of the second object or event to the user; receiving a response from the user based on the indication; and updating the custom class based on the response.

A second aspect of the disclosed implementations is a system that includes one or more memories and one or more processors configured to execute instructions stored in the one or more memories to implement the steps of the method described above.

A third aspect of the disclosed implementations is a non-transitory computer-readable medium storing instructions operable to cause one or more processors to perform operations according to the steps of the method described above.

### BRIEF DESCRIPTION OF THE DRAWINGS

The various aspects of the methods and systems disclosed herein will become more apparent by referring to the examples provided in the following description and drawings in which like reference numbers refer to like elements unless otherwise noted.

FIG. 1 is a diagram of an example of a portion of a vehicle in which the aspects, features, and elements disclosed herein may be implemented.

FIG. 2 is a diagram of an example of a portion of a vehicle transportation and communication system in which the aspects, features, and elements disclosed herein may be implemented.

FIG. 3 is a block diagram of an example internal configuration of a computing device of an electronic computing and communications system in which the aspects, features, and elements disclosed herein may be implemented.

FIG. 4 is a diagram of an example of a system for dynamic refinement of custom classes using zero-shot image classifiers.

FIG. 5 is a diagram of an example of a processing of text prompts and captured images to provide an indication to a user of an identified object in an environment.

FIG. 6 is a diagram of an example of a processing of text prompts, captured images, and user feedback to store and later update a custom class.

FIGS. 7A and 7B together comprise a single flowchart of an example of a process for dynamic refinement of custom classes using zero-shot image classifiers.

### DETAILED DESCRIPTION

To describe some implementations in greater detail, reference is made to the following figures.

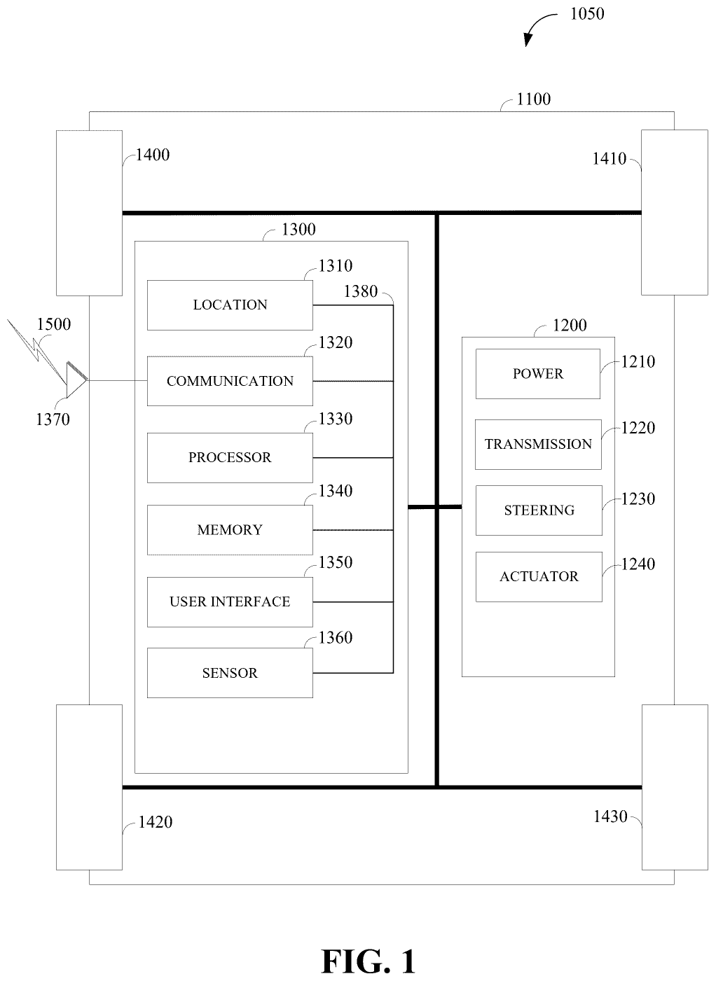

FIG. 1 is a diagram of an example of a vehicle 1050 in which the aspects, features, and elements disclosed herein may be implemented. The vehicle 1050 may include a chassis 1100, a powertrain 1200, a controller 1300, wheels 1400/1410/1420/1430, or any other element or combination of elements of a vehicle. Although the vehicle 1050 is shown as including four wheels 1400/1410/1420/1430 for simplicity, any other propulsion device or devices, such as a propeller or tread, may be used. In FIG. 1, the lines interconnecting elements, such as the powertrain 1200, the controller 1300, and the wheels 1400/1410/1420/1430, indicate that information, such as data or control signals, power, such as electrical power or torque, or both information and power, may be communicated between the respective elements. For example, the controller 1300 may receive power from the powertrain 1200 and communicate with the powertrain 1200, the wheels 1400/1410/1420/1430, or both, to control the vehicle 1050, which can include accelerating, decelerating, steering, or otherwise controlling the vehicle 1050.

The powertrain 1200 includes a power source 1210, a transmission 1220, a steering unit 1230, a vehicle actuator 1240, or any other element or combination of elements of a powertrain, such as a suspension, a drive shaft, axles, or an exhaust system. Although shown separately, the wheels 1400/1410/1420/1430 may be included in the powertrain 1200. A braking system may be included in the vehicle actuator 1240.

The power source 1210 may be any device or combination of devices operative to provide energy, such as electrical energy, chemical energy, or thermal energy. For example, the power source 1210 includes an engine, such as an internal combustion engine, an electric motor, or a combination of an internal combustion engine and an electric motor, and is operative to provide energy as a motive force to one or more of the wheels 1400/1410/1420/1430. In some embodiments, the power source 1210 includes a potential energy unit, such as one or more dry cell batteries, such as nickel-cadmium (NiCd), nickel-zinc (NiZn), nickel metal hydride (NiMH), lithium-ion (Li-ion); solar cells; fuel cells; or any other device capable of providing energy.

The transmission 1220 receives energy from the power source 1210 and transmits the energy to the wheels 1400/1410/1420/1430 to provide a motive force. The transmission 1220 may be controlled by the controller 1300, the vehicle actuator 1240 or both. The steering unit 1230 may be controlled by the controller 1300, the vehicle actuator 1240, or both and controls the wheels 1400/1410/1420/1430 to steer the vehicle. The vehicle actuator 1240 may receive signals from the controller 1300 and may actuate or control the power source 1210, the transmission 1220, the steering unit 1230, or any combination thereof to operate the vehicle 1050.

In some embodiments, the controller 1300 includes a location unit 1310, an electronic communication unit 1320, a processor 1330, a memory 1340, a user interface 1350, a sensor 1360, an electronic communication interface 1370, or any combination thereof. Although shown as a single unit, any one or more elements of the controller 1300 may be integrated into any number of separate physical units. For example, the user interface 1350 and processor 1330 may be integrated in a first physical unit and the memory 1340 may be integrated in a second physical unit. Although not shown in FIG. 1, the controller 1300 may include a power source, such as a battery. Although shown as separate elements, the location unit 1310, the electronic communication unit 1320, the processor 1330, the memory 1340, the user interface 1350, the sensor 1360, the electronic communication interface 1370, or any combination thereof can be integrated in one or more electronic units, circuits, or chips.

In some embodiments, the processor 1330 includes any device or combination of devices capable of manipulating or processing a signal or other information now existing or hereafter developed, including optical processors, quantum processors, molecular processors, or a combination thereof. For example, the processor 1330 may include one or more special purpose processors, one or more digital signal processors, one or more microprocessors, one or more controllers, one or more microcontrollers, one or more integrated circuits, one or more an application-specific integrated circuits (ASICs), one or more field-programmable gate arrays (FPGAs), one or more programmable logic arrays (PLAs), one or more programmable logic controllers (PLCs), one or more state machines, or any combination thereof. The processor 1330 may be operatively coupled with the location unit 1310, the memory 1340, the electronic communication interface 1370, the electronic communication unit 1320, the user interface 1350, the sensor 1360, the powertrain 1200, or any combination thereof. For example, the processor may be operatively coupled with the memory 1340 via a communication bus 1380.

In some embodiments, the processor 1330 may be configured to execute instructions including instructions for remote operation which may be used to operate the vehicle 1050 from a remote location including a data-processing center. The instructions for remote operation may be stored in the vehicle 1050 or received from an external source such as a traffic management center, or server computing devices, which may include cloud-based server computing devices. The processor 1330 may be configured to execute instructions for following a projected path as described herein.

The memory 1340 may include any tangible non-transitory computer-usable or computer-readable medium, capable of, for example, containing, storing, communicating, or transporting machine readable instructions or any information associated therewith, for use by or in connection with the processor 1330. The memory 1340 is, for example, one or more solid state drives, one or more memory cards, one or more removable media, one or more read only memories, one or more random access memories, one or more solid-state drives, one or more disks, including a hard disk, a floppy disk, an optical disk, a magnetic or optical card, or any type of non-transitory media suitable for storing electronic information, or any combination thereof.

The electronic communication interface 1370 may be a wireless antenna, as shown, a wired communication port, an optical communication port, or any other wired or wireless unit capable of interfacing with a wired or wireless electronic communication medium 1500.

The electronic communication unit 1320 may be configured to transmit or receive signals via the wired or wireless electronic communication medium 1500, such as via the electronic communication interface 1370. Although not explicitly shown in FIG. 1, the electronic communication unit 1320 is configured to transmit, receive, or both via any wired or wireless communication medium, such as radio frequency (RF), ultraviolet (UV), visible light, fiber optic, wire line, or a combination thereof. Although FIG. 1 shows a single one of the electronic communication unit 1320 and a single one of the electronic communication interface 1370, any number of communication units and any number of communication interfaces may be used. In some embodiments, the electronic communication unit 1320 can include a dedicated short-range communications (DSRC) unit, a wireless safety unit (WSU), IEEE 802.11p (WiFi-P), a cellular communication unit such as a long-term evolution (LTE) or 5G transceiver, or a combination thereof.

The location unit 1310 may determine geolocation information, including but not limited to longitude, latitude, elevation, direction of travel, or speed, of the vehicle 1050. For example, the location unit includes a global navigation satellite system (GNSS) unit (e.g., a global positioning system (GPS) unit), a wide area augmentation system (WAAS) enabled National Marine-Electronics Association (NMEA) unit, a radio triangulation unit, or a combination thereof. The location unit 1310 can be used to obtain information that represents, for example, a current heading of the vehicle 1050, a current position of the vehicle 1050 in two or three dimensions, a current angular orientation of the vehicle 1050, or a combination thereof.

The user interface 1350 may include any unit capable of being used as an interface by a person, including any of a virtual keypad, a physical keypad, a touchpad, a display, a touchscreen, a speaker, a microphone, a video camera, a sensor, and a printer. The user interface 1350 may be operatively coupled with the processor 1330, as shown, or with any other element of the controller 1300. Although shown as a single unit, the user interface 1350 can include one or more physical units. For example, the user interface 1350 includes an audio interface for performing audio communication with a person, and a touch display for performing visual and touch based communication with the person.

The sensor 1360 may include one or more sensors, such as an array of sensors, which may be operable to provide information that may be used to control the vehicle. The sensor 1360 can provide information regarding current operating characteristics of the vehicle or its surrounding. The sensors 1360 include, for example, a speed sensor, acceleration sensors, a steering angle sensor, traction-related sensors, braking-related sensors, or any sensor, or combination of sensors, that is operable to report information regarding some aspect of the current dynamic situation of the vehicle 1050.

In some embodiments, the sensor 1360 may include sensors that are operable to obtain information regarding the physical environment within or surrounding the vehicle 1050. With regard to within the vehicle 1050, e.g., the in-cabin environment, one or more sensors may detect objects within the vehicle, such as groceries, electronic devices, pets, people, in-vehicle controls, and so on. With respect to surrounding the vehicle, e.g., the external, exterior, or outside environment, one or more sensors may detect road geometry and obstacles, such as fixed obstacles, vehicles, cyclists, and pedestrians. In some embodiments, the sensor 1360 can be or include one or more still or video cameras, laser-sensing systems, infrared-sensing systems, acoustic-sensing systems, or any other suitable type of on-vehicle environmental sensing device, or combination of devices, now known or later developed. In some embodiments, the sensor 1360 and the location unit 1310 are combined.

Although not shown separately, the vehicle 1050 may include a trajectory controller. For example, the controller 1300 may include a trajectory controller. The trajectory controller may be operable to obtain information describing a current state of the vehicle 1050 and a route planned for the vehicle 1050, and, based on this information, to determine and optimize a trajectory for the vehicle 1050. In some embodiments, the trajectory controller outputs signals operable to control the vehicle 1050 such that the vehicle 1050 follows the trajectory that is determined by the trajectory controller. For example, the output of the trajectory controller can be an optimized trajectory that may be supplied to the powertrain 1200, the wheels 1400/1410/1420/1430, or both. In some embodiments, the optimized trajectory can control inputs such as a set of steering angles, with each steering angle corresponding to a point in time or a position. In some embodiments, the optimized trajectory can be one or more paths, lines, curves, or a combination thereof.

One or more of the wheels 1400/1410/1420/1430 may be a steered wheel, which is pivoted to a steering angle under control of the steering unit 1230, a propelled wheel, which is torqued to propel the vehicle 1050 under control of the transmission 1220, or a steered and propelled wheel that steers and propels the vehicle 1050.

A vehicle may include units, or elements not shown in FIG. 1, such as an enclosure, a Bluetooth® module, a frequency modulated (FM) radio unit, a Near Field Communication (NFC) module, a liquid crystal display (LCD) display unit, an organic light-emitting diode (OLED) display unit, a speaker, or any combination thereof.

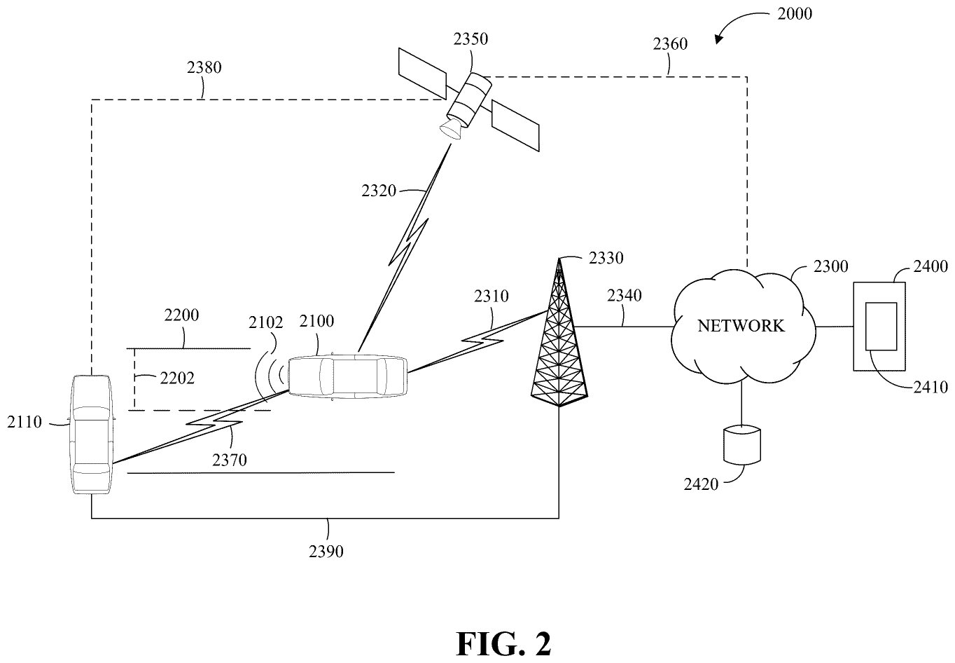

FIG. 2 is a diagram of an example of a portion of a vehicle transportation and communication system 2000 in which the aspects, features, and elements disclosed herein may be implemented. The vehicle transportation and communication system 2000 includes a vehicle 2100, such as the vehicle 1050 shown in FIG. 1, and one or more external objects, such as an external object 2110, which can include any form of transportation, such as the vehicle 1050 shown in FIG. 1, a pedestrian, cyclist, as well as any form of a structure, such as a building. The vehicle 2100 may travel via one or more portions of a transportation network 2200, and may communicate with the external object 2110 via one or more of an electronic communication network 2300. Although not explicitly shown in FIG. 2, a vehicle may traverse an area that is not expressly or completely included in a transportation network, such as an off-road area. In some embodiments the transportation network 2200 may include one or more of a vehicle detection sensor 2202, such as an inductive loop sensor, which may be used to detect the movement of vehicles on the transportation network 2200.

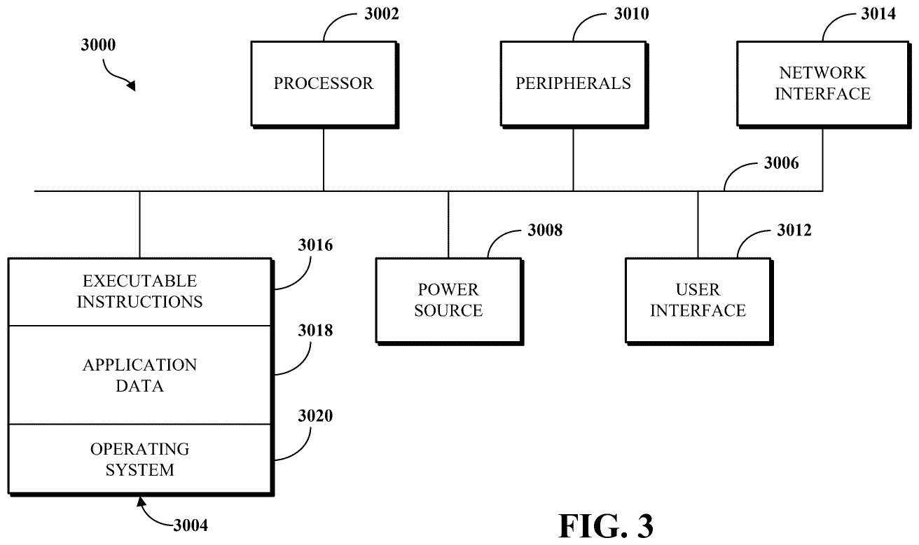

The electronic communication network 2300 may be a multiple-access system that provides for communication, such as voice communication, data communication, video communication, messaging communication, or a combination thereof, between the vehicle 2100, the external object 2110, and a data-processing center 2400. For example, the vehicle 2100 or the external object 2110 may send information to, or receive information from, the data-processing center 2400 or a database server 2420, via the electronic communication network 2300, such as information representing the transportation network 2200. The data-processing center 2400 includes a computing apparatus 2410, that includes some or all of the features of the computing device 3000 shown in FIG. 3. In some implementations, the data-processing center 2400 includes the database server 2420. The database server 2420 is configured for storing data, and it may be implemented by a suitable computer storage medium.

The data-processing center 2400 can monitor and coordinate the movement of vehicles, including autonomous vehicles. The data-processing center 2400 may monitor the state or condition of vehicles, such as the vehicle 2100, and external objects, such as the external object 2110. The data-processing center 2400 can receive vehicle data and infrastructure data including any of: vehicle velocity; vehicle location; vehicle operational state; vehicle destination; vehicle route; vehicle sensor data; external object velocity; external object location; external object operational state; external object destination; external object route; and external object sensor data.

Further, the data-processing center 2400 can establish remote control over one or more vehicles, such as the vehicle 2100, or external objects, such as the external object 2110. In this way, the data-processing center 2400 may tele-operate the vehicles or external objects from a remote location. The computing apparatus 2410 may exchange (send or receive) state data with vehicles, external objects, or computing devices such as the vehicle 2100, the external object 2110, or the database server 2420, via a wireless communication link such as the wireless communication link 2380 or a wired communication link such as the wired communication link 2390.

In some embodiments, the vehicle 2100 or the external object 2110 communicates via the wired communication link 2390, a wireless communication link 2310/2320/2370, or a combination of any number or types of wired or wireless communication links. For example, as shown, the vehicle 2100 or the external object 2110 communicates via a terrestrial wireless communication link 2310, via a non-terrestrial wireless communication link 2320, or via a combination thereof. In some implementations, a terrestrial wireless communication link 2310 includes an Ethernet link, a serial link, a Bluetooth link, an infrared (IR) link, an ultraviolet (UV) link, or any link capable of providing for electronic communication.

A vehicle, such as the vehicle 2100, or an external object, such as the external object 2110, may communicate with another vehicle, external object, or the data-processing center 2400. For example, a host, or subject, vehicle 2100 may receive one or more automated inter-vehicle messages, such as a basic safety message (BSM), from the data-processing center 2400, via a direct communication link 2370, or via an electronic communication network 2300. For example, data-processing center 2400 may broadcast the message to host vehicles within a defined broadcast range, such as three hundred meters, or to a defined geographical area. In some embodiments, the vehicle 2100 receives a message via a third party, such as a signal repeater (not shown) or another remote vehicle (not shown). In some embodiments, the vehicle 2100 or the external object 2110 transmits one or more automated inter-vehicle messages periodically based on a defined interval, such as one hundred milliseconds.

Automated inter-vehicle messages may include vehicle identification information, geospatial state information, such as longitude, latitude, or elevation information, geospatial location accuracy information, kinematic state information, such as vehicle acceleration information, yaw rate information, speed information, vehicle heading information, braking system state data, throttle information, steering wheel angle information, or vehicle routing information, or vehicle operating state information, such as vehicle size information, headlight state information, turn signal information, wiper state data, transmission information, or any other information, or combination of information, relevant to the transmitting vehicle state. For example, transmission state information indicates whether the transmission of the transmitting vehicle is in a neutral state, a parked state, a forward state, or a reverse state.

In some embodiments, the vehicle 2100 communicates with the electronic communication network 2300 via an access point 2330. The access point 2330, which may include a computing device, may be configured to communicate with the vehicle 2100, with the electronic communication network 2300, with the data-processing center 2400, or with a combination thereof via wired or wireless communication links 2310/2340. For example, an access point 2330 is a base station, a base transceiver station (BTS), a Node-B, an enhanced Node-B (eNode-B), a Home Node-B (HNode-B), a wireless router, a wired router, a hub, a relay, a switch, or any similar wired or wireless device. Although shown as a single unit, an access point can include any number of interconnected elements.

The vehicle 2100 may communicate with the electronic communication network 2300 via a satellite 2350, or other non-terrestrial communication device. The satellite 2350, which may include a computing device, may be configured to communicate with the vehicle 2100, with the electronic communication network 2300, with the data-processing center 2400, or with a combination thereof via one or more communication links 2320/2360. Although shown as a single unit, a satellite can include any number of interconnected elements.

The electronic communication network 2300 may be any type of network configured to provide for voice, data, or any other type of electronic communication. For example, the electronic communication network 2300 includes a local area network (LAN), a wide area network (WAN), a virtual private network (VPN), a mobile or cellular telephone network, the Internet, or any other electronic communication system. The electronic communication network 2300 may use a communication protocol, such as the transmission control protocol (TCP), the user datagram protocol (UDP), the internet protocol (IP), the real-time transport protocol (RTP) the Hyper Text Transport Protocol (HTTP), or a combination thereof. Although shown as a single unit, an electronic communication network can include any number of interconnected elements.

In some embodiments, the vehicle 2100 communicates with the data-processing center 2400 via the electronic communication network 2300, access point 2330, or satellite 2350. The data-processing center 2400 may include one or more computing devices, which are able to exchange (send or receive) data from: vehicles such as the vehicle 2100; external objects including the external object 2110; or storage devices such as the database server 2420.

In some embodiments, the vehicle 2100 identifies a portion or condition of the transportation network 2200. For example, the vehicle 2100 may include one or more on-vehicle sensors 2102, such as the sensor 1360 shown in FIG. 1, which includes a speed sensor, a wheel speed sensor, a camera, a gyroscope, an optical sensor, a laser sensor, a radar sensor, a sonic sensor (e.g., a microphone or acoustic sensor), a compass, or any other sensor or device or combination thereof capable of determining or identifying a portion or condition of the transportation network 2200.

The vehicle 2100 may traverse one or more portions of the transportation network 2200 using information communicated via the electronic communication network 2300, such as information representing the transportation network 2200, information identified by one or more on-vehicle sensors 2102, or a combination thereof. The external object 2110 may be capable of all or some of the communications and actions described above with respect to the vehicle 2100.

For simplicity, FIG. 2 shows the vehicle 2100 as the host vehicle, the external object 2110, the transportation network 2200, the electronic communication network 2300, and the data-processing center 2400. However, any number of vehicles, networks, or computing devices may be used. In some embodiments, the vehicle transportation and communication system 2000 includes devices, units, or elements not shown in FIG. 2. Although the vehicle 2100 or external object 2110 is shown as a single unit, a vehicle can include any number of interconnected elements.

Although the vehicle 2100 is shown communicating with the data-processing center 2400 via the electronic communication network 2300, the vehicle 2100 (and external object 2110) may communicate with the data-processing center 2400 via any number of direct or indirect communication links. For example, the vehicle 2100 or external object 2110 may communicate with the data-processing center 2400 via a direct communication link, such as a Bluetooth communication link. Although, for simplicity, FIG. 2 shows one of the transportation network 2200, and one of the electronic communication network 2300, any number of networks or communication devices may be used. The vehicle 2100 (and external object 2110) can be monitored or coordinated by the data-processing center 2400, can be operated autonomously or by a human driver, and can exchange (send and receive) vehicle data relating to the state or condition of the vehicle and its surroundings including any of vehicle velocity (e.g., vehicle speed and vehicle trajectory, or heading); vehicle location; vehicle operational state; vehicle destination; vehicle route; vehicle sensor data; external object velocity; external object location, and so on.

FIG. 3 shows a block diagram of an example of a computing device 3000 in which certain aspects, features, and elements disclosed herein may be implemented. The computing device 3000 includes components or units, such as a processor 3002, a memory 3004, a bus 3006, a power source 3008, peripherals 3010, a user interface 3012, a network interface 3014, other suitable components, or a combination thereof. One or more of the memory 3004, the power source 3008, the peripherals 3010, the user interface 3012, or the network interface 3014 can communicate with the processor 3002 via the bus 3006.

The processor 3002 is a central processing unit, such as a microprocessor, and can include single or multiple processors having single or multiple processing cores. Alternatively, the processor 3002 can include another type of device, or multiple devices, configured for manipulating or processing information. For example, the processor 3002 can include multiple processors interconnected in one or more manners, including hardwired or networked. The operations of the processor 3002 can be distributed across multiple devices or units that can be coupled directly or across a local area or other suitable type of network. The processor 3002 can include a cache, or cache memory, for local storage of operating data or instructions.

The memory 3004 includes one or more memory components, which may each be volatile memory or non-volatile memory. For example, the volatile memory can be random access memory (RAM) (e.g., a DRAM module, such as DDR SDRAM). In another example, the non-volatile memory of the memory 3004 can be a disk drive, a solid state drive, flash memory, or phase-change memory. In some implementations, the memory 3004 can be distributed across multiple devices. For example, the memory 3004 can include network-based memory or memory in multiple clients or servers performing the operations of those multiple devices.

The memory 3004 can include data for immediate access by the processor 3002. For example, the memory 3004 can include executable instructions 3016, application data 3018, and an operating system 3020. The executable instructions 3016 can include one or more application programs, which can be loaded or copied, in whole or in part, from non-volatile memory to volatile memory to be executed by the processor 3002. For example, the executable instructions 3016 can include instructions for performing techniques of this disclosure. In some implementations, the application data 3018 can include functional programs, such as a computational programs, analytical programs, database programs, and so on. The operating system 3020 can be, for example, Microsoft Windows®, Mac OS X®, or Linux®; an operating system for a mobile device, such as a smartphone or tablet device; or an operating system for a non-mobile device, such as a mainframe computer.

The power source 3008 provides power to the computing device 3000. For example, the power source 3008 can be an interface to an external power distribution system. In another example, the power source 3008 can be a battery, such as where the computing device 3000 is a mobile device or is otherwise configured to operate independently of an external power distribution system. In some implementations, the computing device 3000 may include or otherwise use multiple power sources. In some such implementations, the power source 3008 can be a backup battery.

The peripherals 3010 may include one or more sensors, detectors, or other devices configured for monitoring the computing device 3000 or the environment around the computing device 3000. For example, the peripherals 3010 can include a geolocation component, such as a GNSS location unit (e.g., GPS). In another example, the peripherals can include a temperature sensor for measuring temperatures of components of the computing device 3000, such as the processor 3002. In some implementations, the computing device 3000 can omit the peripherals 3010.

The user interface 3012 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 3014 provides a connection or link to a network (e.g., the electronic communication network 2300 shown in FIG. 2). The network interface 3014 can be a wired network interface or a wireless network interface. The computing device 3000 can communicate with other devices via the network interface 3014 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof. For example, the computing device 3000 can communicate with a database server, such as the database server 2420 of FIG. 2.

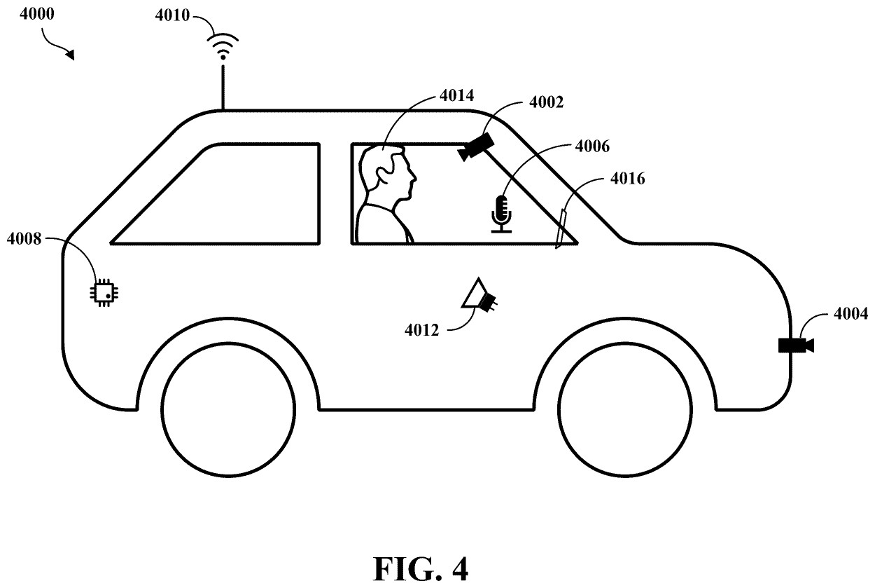

FIG. 4 is a diagram of an example of a system, for dynamic refinement of custom classes using zero-shot image classifiers, that is integrated with a vehicle 4000. The vehicle 4000 may be, for example, the vehicle 1050 of FIG. 1.

The vehicle 4000 includes an image-capturing device 4004, which may be an instance of the sensor 1360 of FIG. 1, for capturing images of an exterior environment of the vehicle 4000 (and objects and/or events therein). The image-capturing device 4004 is shown in FIG. 4 as a front-facing device for capturing images ahead of the vehicle, but the image-capturing device 4004, or multiple such image-capturing devices 4004, may face any direction with respect to the vehicle, such as side-, up-, down-, and rear-facing. The images captured by the image-capturing device 4004 may comprise data of one or more suitable image types, such as optical images, lidar images, infrared images, radar images, or sonar images. Accordingly, the image-capturing device 4004 may comprise an optical camera (e.g., still camera or video camera), a lidar instrument (e.g., solid state or rotating lidar), an infrared or thermal camera (e.g., still camera or video), a radar device (e.g., continuous-wave or pulse radar), or a sonar instrument (e.g., active or passive sonar).

The vehicle 4000 may include one or more additional image-capturing devices 4002, which may be an instance of the sensor 1360 of FIG. 1, for capturing images of an interior environment of the vehicle 4000 (and objects and/or events therein). Specifically, the image-capturing device 4002 may capture images of the face of a driver 4014 (or of a passenger) of the vehicle 4000. The image-capturing device 4002 may implement or be a part of an eye-tracking system capable of determining a gaze direction or a gaze shift of the driver 4014, for example, straight ahead, to the left, to the right, and so on. In some implementations, the gaze direction of the driver 4014 may be utilized by the system to determine an area of interest that the driver 4014 may be looking toward, which the system can use to adjust a field of view of the image-capturing device 4004 to more closely align with the area of interest. In some implementations, the gaze direction of the driver 4014 may be utilized by the system to determine an area of interest that the driver 4014 may be looking toward while providing spoken prompts to the system, which the system can use to infer context for the prompt. In some implementations, the gaze shift of the driver 4014 may be interpreted by the system as a response (or a partial response) to a notification to the driver 4014 provided by the system as described further herein later. While an optical camera may be well suited for capturing images of the face and/or eyes of the driver 4014, the images captured by the image-capturing device 4002 may comprise data of one or more suitable image types, such as those described with reference to the image-capturing device 4004 above.

The vehicle 4000 includes a microphone 4006, which may be an instance of the sensor 1360 of FIG. 1, for detecting spoken prompts from a user, such as queries or commands from the driver 4014 (or from other occupants, not shown in FIG. 4). In some implementations, the microphone 4006 may be a directional microphone, such as an array of microphones, for determining an orientation of the head of the driver 4014, for example, if the driver 4014 is looking straight ahead, to the left, to the right, and so on. In some implementations, the orientation of the head of the driver 4014 may be utilized by the system to determine an area of interest that the driver 4014 may be looking toward while providing spoken prompts to the system, which the system can use to infer context for the prompt or to adjust a field of view of the image-capturing device 4004 to more closely align with the area of interest. In some implementations, the microphone 4006 may implement or be a part of an emotion-recognition system capable of extracting meaning from sentiment or prosody of a spoken prompt or response of the driver 4014. Such meaning may include, for example, positive, negative, or neutral sentiment; excitement, happiness, or anger emotions; agreement or disagreement; or context for

### The Spoken Prompt or Response.

The vehicle 4000 includes a computing device 4008, which may be an instance of the computing device 3000 of FIG. 3. The computing device 4008 may be configured to execute or partially execute several tasks, such as processing images captured by the image-capturing device 4004 and/or the image-capturing device 4002; processing audio captured by the microphone 4006; executing sentiment analysis or prosody analysis of captured audio; executing CLIP tasks such as generating image embeddings of captured images and text embeddings of spoken (text) prompts; and communicating with additional computing devices, such as cloud-based computing or storage devices, for offloading or partitioning tasks that may be too computationally intensive to be performed locally by the computing device 4008, such as one or more of the tasks listed immediately above. One or more of these tasks are described more fully below. The additional computing devices may be part of a data-processing center, such as the data processing center 2400 of FIG. 2. The computing device 4008 may utilize a communication interface 4010, such as a wireless antenna, for unidirectional or bidirectional communication to the additional computing devices. The communication interface 4010 may be an instance of the communication interface 1370 of FIG. 3, and the communication may occur via a network, such as the network 2300 of FIG. 2.

The vehicle 4000 includes a speaker 4012 (or multiple such speakers), which may be an instance of the user interface 1350 of FIG. 1. The speaker 4012 is configured to provide audible notifications to the driver 4014 regarding objects or events that the system has identified in the exterior environment. The audible notifications may comprise AI-generated spoken language.

The vehicle 4000 optionally includes a graphical display 4016 (or multiple such displays), which may be an instance of the user interface 1350 of FIG. 1. The graphical display 4016 is configured to provide visual notifications to the driver 4014 regarding objects or events that the system has identified in the exterior environment. The visual notifications may comprise AI-generated text, graphics, images, and/or videos.

The audible and visual notifications regarding objects or events are respective example implementations of indications that the system may provide to the driver 4014 regarding the objects or events. Other examples of implementations of indications regarding objects or events, which are not depicted in FIG. 4, include haptic notifications, such as vibrations from an in-seat vibrator; vehicle trajectory notifications, such as an autonomous vehicle altering its trajectory or a navigation system altering its route; vehicle speed notifications, such as a vehicle decelerating; illumination notifications, such as an in-cabin lighting system activating a certain lighting pattern and/or intensity; and so on.

In some implementations, the image-capturing device 4002, the image-capturing device 4004, the speaker 4012, the microphone 4006, and the graphical display 4016 may be components of an in-vehicle infotainment system (IVI).

In some implementations, the image-capturing device 4002 and/or the image-capturing device 4004 may be activated, e.g., begin capturing and/or recording images (e.g., optical images, lidar images, infrared images, radar images, and/or sonar images) in response to a trigger. The trigger may be a suitable event, such as the system detecting a mobile device or key fob entering the cabin environment by a communication channel between the mobile device or the key fob and the vehicle 4000; the system detecting an occupant entering the cabin environment by the image-capturing device 4002 or the image-capturing device 4004 or by an in-cabin proximity sensor; the system detecting an occupant speaking by the microphone 4006; the system detecting the vehicle 4000 waking from a dormant state, for example, via the computing device 4008; or the system detecting the vehicle 4000 departing from an origin by a global navigation satellite system (GNSS). In the case of the system detecting an occupant entering the cabin environment by the image-capturing device 4002 or the image-capturing device 4004, the image-capturing device 4002 and/or the image-capturing device 4004 may be, for example, in a low-power or stand-by state prior to the trigger, where the image-capturing device 4002 and/or the image-capturing device 4004 wake up periodically to capture one or a few images at a low resolution that is sufficient to detect whether an occupant has entered the vehicle 4000. Upon the trigger, the image-capturing device 4002 and/or the image-capturing device 4004 may begin capturing, for example, higher resolution images at a higher frame rate (or sampling rate) than compared to the low-power or stand-by state.

Following the activation of the image-capturing device 4004 and subsequent capturing of images thereby, the system begins generating image embeddings of the captured images (or a subset thereof) using a trained CLIP model. An image embedding comprises a high-dimensional vector representation of an image, capturing its essential features and content. An image embedding enables the CLIP model to compare and relate the image to textual descriptions in the same embedding space, i.e., to compare image embeddings to text embeddings, which are described below. This process allows the CLIP model to perform tasks like image classification and retrieval by matching textual descriptions to relevant images. The text embedding also supports zero-shot learning, enabling the model to identify objects or events (or concepts) in images based on textual descriptions without explicit training on those specific tasks. Generating image embeddings and/or comparing image embeddings to text embeddings may be executed by one or more computing devices external to the vehicle 4000, such as a computing apparatus 2410 in the data-processing center 2400 of FIG. 2. In such case, the computing device 4008 of the vehicle 4000 causes the captured images to be transmitted to the one or more external computing devices via the communication interface 4010.

Also following the activation of the image-capturing device 4004 and subsequent capturing of images thereby, the system listens for a spoken prompt from a user of the vehicle 4000 via the microphone 4006. The spoken prompt may be formulated in a suitable manner, such as in complete or incomplete sentences. The system may utilize natural language processing (NLP) to processes voice audio captured by the microphone 4006 into text that may be referred to herein as the text prompt, where the NLP processing may be executed by one or more computing devices external to the vehicle 4000, such as a computing apparatus 2410 in the data-processing center 2400 of FIG. 2. In such case, the computing device 4008 of the vehicle 4000 causes the captured voice audio to be transmitted to the one or more external computing devices via the communication interface 4010.

The system subsequently generates a text embedding of the text prompt using the trained CLIP model. A text embedding comprises a high-dimensional vector representation of a textual description, capturing its essential meaning and context. A text embedding enables the CLIP model to compare and relate the text to image embeddings in the same embedding space, i.e., to compare image embeddings to text embeddings as described above. Generating text embeddings and/or comparing text embeddings to image embeddings may be executed by one or more computing devices external to the vehicle 4000, such as a computing apparatus 2410 in the data-processing center 2400 of FIG. 2. In such case, the computing device 4008 of the vehicle 4000 causes the captured images to be transmitted to the one or more external computing devices via the communication interface 4010.

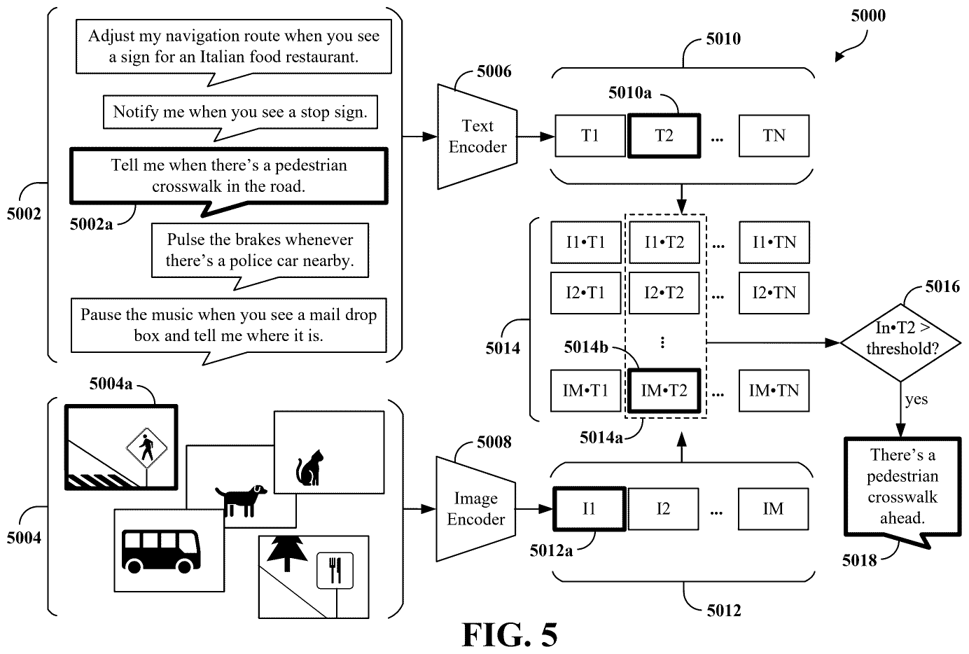

FIG. 5 shows a diagram of an example of a processing 5000 of one or more text prompts 5002 and one or more images 5004 to provide at least one indication 5018 to a user of an identified object in an environment. The environment may be an environment that is exterior to the cabin of a vehicle, such as the vehicle 4000 of FIG. 4. The various components and devices shown in FIG. 5 comprise a system that implements a CLIP model and a zero-shot classifier which were described earlier. Some or all of the processing 5000 by the system may be implemented by one or more computing devices, such as the computing device 4008 of FIG. 4 and/or additional computing devices such as cloud-based computing or storage devices. The text prompts 5002 may correspond to language spoken by the user and captured as audio by a microphone, such as the microphone 4006 of FIG. 4. The images 5004 may be captured by an image-capturing device, such as the image capturing device 4004 of FIG. 4.

The system comprises a text encoder 5006 that generates text embeddings 5010 from the text prompts 5002, labeled as “T1, T2, . . . TN.” Similarly, the system comprises an image encoder 5008 that generates image embeddings 5012 from the images 5004, labeled as “I1, I2, . . . IM.” The quantity M of text embeddings 5002 may not equal the quantity N of image embeddings 5004; in fact, the system likely captures significantly more images 5004 than text prompts 5002 because the image-capturing device, such as a video camera or a lidar device, may continually capture images 5004 at a given frame rate. After captured at least one text prompt 5002 and at least one image 5004, the system computes respective similarity scores 5014 between each text embedding 5010 and each image embedding 5012, labeled as “I1•T1, I1•T2, . . . IM•TN.” In the context of CLIP, a similarity score is a cosine similarity determined by computing a dot product between a respective text embedding 5010 and a respective image embedding 5012.

Assume the user provides the text prompt 5002a that is outlined in bold, which includes the text: “Tell me when there's a pedestrian crossing in the road.” The text encoder 5006 generates the corresponding text embedding 5010a, labeled as “T2.” The image-capturing device captures the images 5004, and the image encoder 5008 generates respective image embeddings 5012, labeled as “I1, I2, . . . IM.” The system computes similarity scores 5014a between the text embedding 5010a and each of the image embeddings 5012, which comprises individual similarity scores “I1•T2, I2•T2, . . . IM•T2.” Raw similarity scores may range from −1 to 1, e.g., for cosine similarity, and these raw similarity scores may be normalized to a range more suitable for subsequent computations, rankings, or comparisons, such as a range from 0 to 1. The system ranks the similarity scores 5014a and selects a highest similarity score 5014b (e.g., a highest scoring image-text pair) as a most relevant match. A threshold comparator 5016 compares the highest similarity score 5014b to a predefined threshold. If the highest similarity score 5014b exceeds the threshold, the system identifies the object or event in the image 5004a that is described by the text prompt 5002a, e.g., a pedestrian crossing, and provides an indication 5018 to the user. The indication 5018 shown in FIG. 5 comprises a text-to-speech notification output by a speaker, such as the speaker 4012 of FIG. 4.

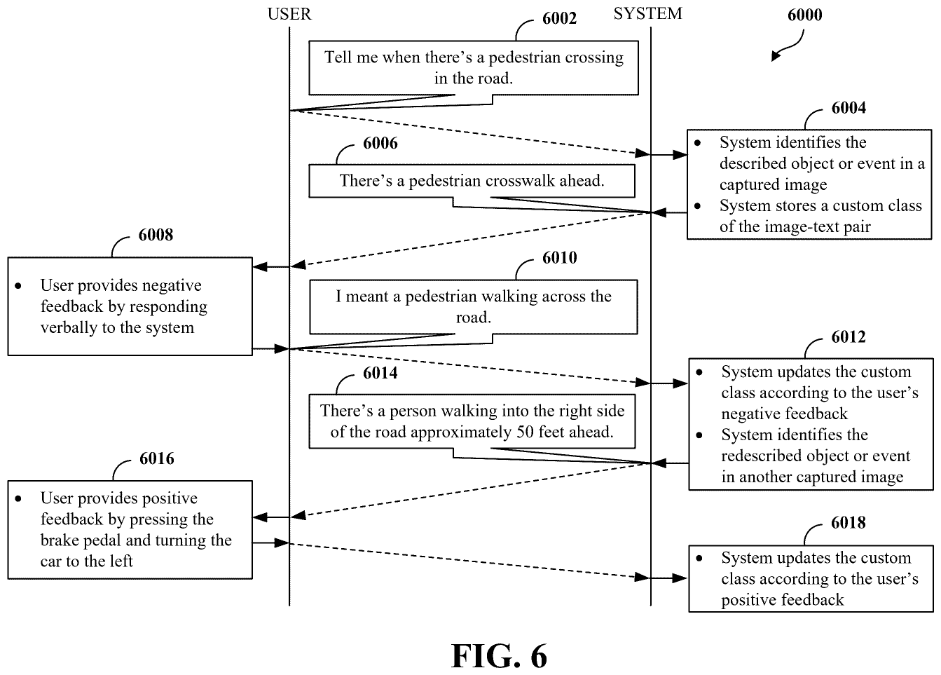

FIG. 6 is shows diagram of an example of a processing 6000 of text prompts, captured images, and user feedback to store and later update a custom class. A user provides a first text prompt 6002, “Tell me when there's a pedestrian crossing in the road.” In a sequence of processing tasks 6004, the system, which may be the system described with respect to FIG. 5, utilizes a CLIP model to identify an object or event in a captured image that corresponds to the object or event described in the text prompt 6002, in this example, the object being a pedestrian crosswalk. In the sequence of processing tasks 6004, the system stores the text prompt and the captured image (e.g., the image-text pair) as a custom class. The system provides an indication 6006 to notify the user that it has identified a pedestrian crosswalk, “There's a pedestrian crosswalk ahead.”

The user provides a response 6008, in the form of a second text prompt 6010, “I meant a pedestrian walking across the road.” The response 6008 comprises negative feedback, indicating that the system has made an incorrect match between the description provided in the text prompt 6002 and the captured image. Upon receiving the response 6008, the system executes a sequence of processing tasks 6012, including updating the custom class according to the negative feedback of the response 6008. Updating the custom class may involve one or more of the following steps.

Compute a loss value using a loss function. In the CLIP model, the loss function may be a contrastive loss, which compares predicted similarity scores to desired similarity scores. A high loss indicates a large discrepancy between predicted and actual matches (e.g., the CLIP model thought the description of a pedestrian crossing in the road matched the image of the pedestrian crosswalk in the road strongly). A low loss indicates predictions of the CLIP model are closer to desired outcomes (e.g., the CLIP model correctly associates a description of a pedestrian crossing in the road with an image of a pedestrian walking across the road.). The loss value quantifies an error of the CLIP model, providing a basis for how much and in what direction to adjust parameters of the CLIP model.

Adjust the parameters of the CLIP model to minimize the loss and improve accuracy. First, backpropagation is performed by calculating gradients of the CLIP model, which are partial derivatives of the loss with respect to each parameter. This tells the CLIP model how to change each parameter to reduce the loss. Next, optimization is performed by using the gradients to update the parameters. Common optimization algorithms include Stochastic Gradient Descent (SGD) and Adam. Finally, the parameters are adjusted in a respective direction of a gradient that reduces the loss. If a gradient indicates that increasing a parameter will reduce the loss, the CLIP model increases that parameter; if a gradient indicates that decreasing a parameter will increase the loss, the CLIP model decreases that parameter

In the sequence of processing tasks 6012, the system utilizes the CLIP model to identify another object or event in another captured image that corresponds to the redescribed object or event in the response 6008, in this example, a person walking across the road. Upon identifying the redescribed object or event, the system provides an indication 6014 to notify the user that it has identified a pedestrian walking across the road, “There's a person walking into the right side of the road approximately 50 feet ahead.” In this case, the user provides a response 6016, in the form of a responsive action taken by the user and detected by the system: the user presses the brake pedal and turns the vehicle to the left. The system may detect the response action using one or more sensors, such as instances of the sensor 1360 of FIG. 1. The response 6016 comprises positive feedback, indicating that the system has made an correct match between the description provided in the text prompt 6002 and the captured image. Upon receiving the response 6016, the system executes a sequence of processing tasks 6018, including updating the custom class according to the positive feedback of the response 6016. Updating the custom class according to positive feedback may involve one or more of the steps described above with respect to updating the custom class with respect to negative feedback.

For simplicity of explanation, each technique, or process, is depicted and described herein as a series of steps or operations. However, the steps or operations of the techniques in accordance with this disclosure can occur in various orders and/or concurrently. Additionally, other steps or operations not presented and described herein may be used. Furthermore, not all illustrated steps or operations may be required to implement a technique in accordance with the disclosed subject matter.

The technique 7000 described below is a technique for dynamic refinement of custom classes using zero-shot image classifiers. This technique may be implemented by a system whose components may be internal and/or external to a vehicle, such as the computing device 4008 of FIG. 4 and a computing apparatus 2410 of the data center 2400 of FIG. 2.

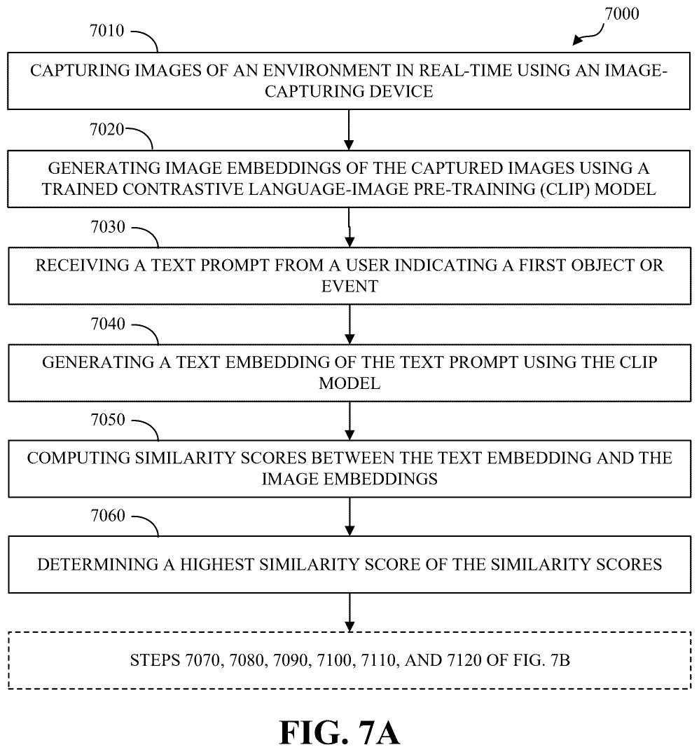

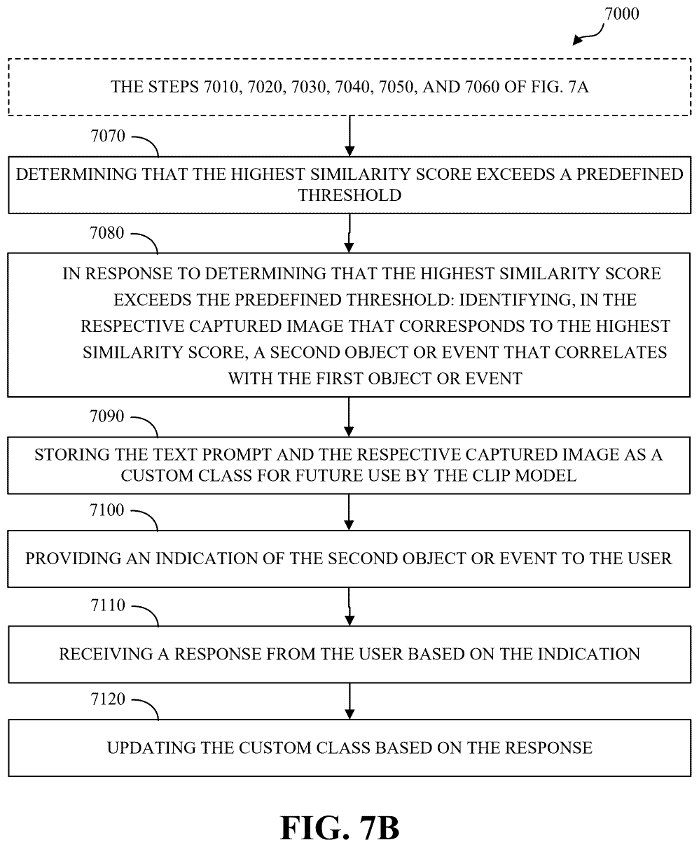

FIGS. 7A and 7B together comprise a single flowchart of an example of a process for dynamic refinement of custom classes using zero-shot image classifiers. The step 7010 comprises capturing images of an environment in real-time using an image-capturing device. The image-capturing device may one or more of the image-capturing devices 4004 of FIG. 4. The images may be the images 5004 of FIG. 5.

In some implementations, the technique further comprises: capturing images of the environment outside of a vehicle; and receiving the text prompt from the user within the vehicle. The vehicle may be the vehicle 4000 of FIG. 4. In some implementations, the user may be driving the vehicle.

In some implementations, the image-capturing device comprises at least one of: an optical device adapted to capture optical images; a lidar device adapted to capture lidar images; an infrared device adapted to capture infrared images; a radar device adapted to capture radar images; or a sonar device adapted to capture sonar images.

In some implementations, the technique further comprises: detecting a gaze direction of the user using an eye-tracking system to identify an area of interest within the environment; and adjusting a field of view of the image-capturing device based on the gaze direction to capture images of the environment to more closely align with the area of interest. The eye-tracking system may comprise a camera, such as the image-capturing device 4002 of FIG. 4.

The step 7020 comprises generating image embeddings of the captured images using a trained CLIP model. The image embeddings may be generated by an image encoder, such as the image encoder 5008 of FIG. 5. The image embeddings may be the image embeddings 5012 of FIG. 5.

The step 7030 comprises receiving a text prompt from a user indicating a first object or event. The text prompt may be an individual one of the text prompts 5002 of FIG. 5, such as the text prompt 5002a. In some implementations, the text prompt may be received by a microphone, such as the microphone 4006 of FIG. 4.

The step 7040 comprises generating a text embedding of the text prompt using the CLIP model. The text embedding may be generated by a text encoder, such as the text encoder 5006 of FIG. 5. The text embedding may be an individual one of the text embeddings 5010 of FIG. 5, such as the text embedding 5010a.

The step 7050 comprises computing similarity scores between the text embedding and the image embeddings. The similarity scores may be a subset of the similarity scores 5014 of FIG. 5, such as the similarity scores 5014a. The similarity scores may be computed by a computing device, such as the computing device 4008 of FIG. 4 or a computing apparatus 2410 of the data center 2400 of FIG. 2.

The step 7060 comprises determining a highest similarity score of the similarity scores. In some implementations, the highest similarity score may be a numerically largest similarity score, for example, if the similarity scores range from 0 to 1. In some implementations, the highest similarity score may be a most positive similarity score, for example, if the similarity scores range from −1 to 1.

In some implementations, the technique further comprises: detecting a gaze direction of the user using an eye-tracking system to identify an area of interest within the environment; and prioritizing objects or events within the area of interest when computing the similarity scores. Prioritizing objects or events may include cropping the captured images to the area of interest. The eye-tracking system may comprise a camera, such as the image-capturing device 4002 of FIG. 4.

The step 7070 comprises determining that the highest similarity score exceeds a predefined threshold. This determination may be performed by a threshold comparator, such as the threshold comparator 5016 of FIG. 5. In some implementations, the highest similarity score exceeds the threshold when it is numerically larger than the threshold, for example, if the similarity scores range from 0 to 1. In some implementations, the highest similarity score exceeds the threshold when it is more positive than the threshold, for example, if the similarity scores range from-1 to 1.

The step 7080 comprises, in response to determining that the highest similarity score exceeds the predefined threshold, identifying, in the respective captured image that corresponds to the highest similarity score, a second object or event that correlates with the first object or event.

The step 7090 comprises storing the text prompt and the respective captured image as a custom class for future use by the CLIP model. This step may be a step in the sequence of processing tasks 6004 of FIG. 6. In some implementations, the custom class may be stored in a remote database to enable access and use by multiple devices. The multiple devices may include, for example, different vehicles operated by the user or different vehicles operated by different users. In some implementations, the technique further comprises utilizing the updated custom class in real-time to enhance an accuracy of identifying objects or events in subsequent captured images.

The step 7100 comprises providing an indication of the second object or event to the user. In some implementations, the indication may be provided by a text-to-speech system. In some implementations, the indication may be provided by highlighting the second object or event within a graphical display comprising at least one of: an infotainment display in a vehicle; a head-up display in a vehicle; a display of a mobile device; or a display of a head-worn device. The graphical display may be in instance of the user interface 1350 of FIG. 1. Highlighting the second object may comprise depicting, animating, or otherwise emphasizing an image, rendering, or representation of the second object.

In some implementations, the predefined threshold may be configurable by the user. For example, the user may prefer a higher threshold to avoid false positive indications or a lower threshold to avoid missing important indications. Further, the predefined threshold may be based on the first object or event, based on a time of day, based on a current location or destination of the user (e.g., a current location or destination of a vehicle being driven by the user), and so on. As an example, the user may prefer a lower threshold for indications concerning traffic signs and a higher threshold for indications concerning restaurants. As another example, the user may prefer lower thresholds in the morning and higher thresholds in the evening. As another example, the user may prefer to turn off all indications (e.g., infinite threshold) when driving to work and to apply default thresholds at all other times.

The step 7110 comprises receiving a response from the user based on the indication.

In some implementations, the technique further comprises: receiving the response comprising a voice input captured by a microphone; and processing the voice input using a natural language processing system to extract meaning from syntax or semantics or both. The microphone may be the microphone 4006 of FIG. 4.

In some implementations, the technique further comprises: receiving the response comprising a voice input captured by a microphone; and processing the voice input using an emotion-recognition system to extract meaning from sentiment or prosody or both. The microphone may be the microphone 4006 of FIG. 4.

In some implementations, the technique further comprises: capturing the images of the environment outside of a vehicle; receiving the text prompt from a user within the vehicle; and receiving the response comprising a change in trajectory of the vehicle. A change in trajectory of the vehicle may be, for example, when the vehicle turns or swerves. The change in trajectory may be detected by one or more sensors, such as one or more instances of the sensor 1360 of FIG. 1.

In some implementations, the technique further comprises: capturing the images of the environment outside of a vehicle; receiving the text prompt from a user within the vehicle;

and receiving the response comprising a change in velocity of the vehicle. A change in velocity of the vehicle may be, for example, when the vehicle accelerates or decelerates. The change in velocity may be detected by one or more sensors, such as one or more instances of the sensor 1360 of FIG. 1.

In some implementations, the technique further comprises receiving the response comprising shift in facial expression of the user determined by a facial analysis system. For example, the user's facial expression could convey disappointment, which could be interpreted as negative feedback, or the user's facial expression could convey happiness, which could be interpreted as positive feedback. The facial analysis system may comprise a camera, such as the image-capturing device 4002 of FIG. 4.

The step 7120 comprises updating the custom class based on the response. In some implementations, updating the custom class may comprise: determining a loss according to a loss function; determining a gradient of the loss with respect to a parameter of the CLIP model; and adjusting the parameter in a direction of the gradient that reduces the loss. Determining the loss, determining the gradient, and adjusting the parameter may be performed by one or more computing devices, such as the computing device 4008 of FIG. 4 and a computing apparatus 2410 of the data center 2400 of FIG. 2.

In some implementations, the technique further comprises incorporating additional captured images, additional text prompts from additional users, additional indications of additional second objects or events to the additional users, and additional responses from the additional users to collaboratively update the custom class.

The above-described techniques can be implemented as a method, a system, and a non-transitory computer-readable medium, for example, as described below.

In an example implementation as a method, the method comprises: capturing images of an environment in real-time using an image-capturing device; generating image embeddings of the captured images using a trained Contrastive Language-Image Pre-training (CLIP) model; receiving a text prompt from a user indicating a first object or event; generating a text embedding of the text prompt using the CLIP model; computing similarity scores between the text embedding and the image embeddings; determining a highest similarity score of the similarity scores; determining that the highest similarity score exceeds a predefined threshold; in response to determining that the highest similarity score exceeds the predefined threshold: identifying, in the respective captured image that corresponds to the highest similarity score, a second object or event that correlates with the first object or event; storing the text prompt and the respective captured image as a custom class for future use by the CLIP model; providing an indication of the second object or event to the user; receiving a response from the user based on the indication; and updating the custom class based on the response.

In some implementations, the method further comprises: capturing images of the environment outside of a vehicle; and receiving the text prompt from the user within the vehicle.

In some implementations, the method further comprises: providing the indication by a text-to-speech system.

In some implementations, the image-capturing device comprises at least one of: an optical device adapted to capture optical images; a lidar device adapted to capture lidar images;

an infrared device adapted to capture infrared images; a radar device adapted to capture radar images; or a sonar device adapted to capture sonar images.

In some implementations, the method further comprises: providing the indication by highlighting the second object or event within a graphical display comprising at least one of:

an infotainment display in a vehicle; a head-up display in a vehicle;

a display of a mobile device; or a display of a head-worn device.

In some implementations, the predefined threshold is configurable by the user.

In some implementations, the method further comprises: receiving the response comprising a voice input captured by a microphone; and processing the voice input using a natural language processing system to extract meaning from syntax or semantics or both.

In some implementations, the method further comprises: receiving the response comprising a voice input captured by a microphone; and processing the voice input using an emotion-recognition system to extract meaning from sentiment or prosody or both.

In some implementations, the method further comprises: capturing the images of the environment outside of a vehicle; receiving the text prompt from a user within the vehicle; and receiving the response comprising a change in trajectory of the vehicle.

In some implementations, the method further comprises: capturing the images of the environment outside of a vehicle; receiving the text prompt from a user within the vehicle; and receiving the response comprising a change in velocity of the vehicle.

In some implementations, the method further comprises: receiving the response comprising shift in facial expression of the user determined by a facial analysis system.

In some implementations, the method further comprises: detecting a gaze direction of the user using an eye-tracking system to identify an area of interest within the environment; and prioritizing objects or events within the area of interest when computing the similarity scores.

In some implementations, the method further comprises: detecting a gaze direction of the user using an eye-tracking system to identify an area of interest within the environment; and adjusting a field of view of the image-capturing device based on the gaze direction to capture images of the environment to more closely align with the area of interest.

In some implementations, the method further comprises: utilizing the updated custom class in real-time to enhance an accuracy of identifying objects or events in subsequent captured images.

In some implementations, the method further comprises: incorporating additional captured images, additional text prompts from additional users, additional indications of additional second objects or events to the additional users, and additional responses from the additional users to collaboratively update the custom class.

In some implementations, the method further comprises: storing the custom class in a remote database to enable access and use by multiple devices.

In another example implementation as a system, the system comprises one or more memories; and one or more processors configured to execute instructions stored in the one or more memories to: capture images of an environment in real-time using an image-capturing device; generate image embeddings of the captured images using a trained Contrastive Language-Image Pre-training (CLIP) model; receive a text prompt from a user indicating a first object or event; generate a text embedding of the text prompt using the CLIP model; compute similarity scores between the text embedding and the image embeddings; determine a highest similarity score of the similarity scores; determine that the highest similarity score exceeds a predefined threshold; in response to determining that the highest similarity score exceeds the predefined threshold: identify, in the respective captured image that corresponds to the highest similarity score, a second object or event that correlates with the first object or event; store the text prompt and the respective captured image as a custom class for future use by the CLIP model; provide an indication of the second object or event to the user; receive a response from the user based on the indication; and update the custom class based on the response.

In some implementations, the instructions include instructions to: capture images of the environment outside of a vehicle; and receive the text prompt from a user driving the vehicle.

In another example implementation as a non-transitory computer-readable medium, the non-transitory computer-readable medium stores instructions operable to cause one or more processors to perform operations comprising: capturing images of an environment in real-time using an image-capturing device; generating image embeddings of the captured images using a trained Contrastive Language-Image Pre-training (CLIP) model; receiving a text prompt from a user indicating a first object or event; generating a text embedding of the text prompt using the CLIP model; computing similarity scores between the text embedding and the image embeddings; determining a highest similarity score of the similarity scores; determining that the highest similarity score exceeds a predefined threshold; in response to determining that the highest similarity score exceeds the predefined threshold: identifying, in the respective captured image that corresponds to the highest similarity score, a second object or event that correlates with the first object or event; storing the text prompt and the respective captured image as a custom class for future use by the CLIP model; providing an indication of the second object or event to the user; receiving a response from the user based on the indication; and updating the custom class based on the response.

In some implementations, the operations further comprise: updating the custom class by determining a loss according to a loss function; determining a gradient of the loss with respect to a parameter of the CLIP model; and adjusting the parameter in a direction of the gradient that reduces the loss.

As used herein, the terminology “example,” “embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify,” or any variations thereof, includes selecting, ascertaining, computing, looking up, receiving, determining, establishing, obtaining, or otherwise identifying or determining in any manner whatsoever using one or more of the devices shown and described herein.

As used herein, the terminology “or” is intended to mean an inclusive “or” rather than an exclusive “or”. That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

The above-described aspects, examples, and implementations have been described to allow easy understanding of the disclosure are not limiting. On the contrary, the disclosure covers various modifications and equivalent arrangements included within the scope of the appended claims, which scope is to be accorded the broadest interpretation to encompass all such modifications and equivalent structure as is permitted under the law.

What is claimed is:

1. A method, comprising:
capturing images of an environment in real-time using an image-capturing device;
generating image embeddings of the captured images using a trained Contrastive Language-Image Pre-training (CLIP) model;
receiving a text prompt from a user indicating a first object or event;
generating a text embedding of the text prompt using the CLIP model;
computing similarity scores between the text embedding and the image embeddings;
determining a highest similarity score of the similarity scores;
determining that the highest similarity score exceeds a predefined threshold;
in response to determining that the highest similarity score exceeds the predefined threshold:
identifying, in the respective captured image that corresponds to the highest similarity score, a second object or event that correlates with the first object or event;
storing the text prompt and the respective captured image as a custom class for future use by the CLIP model;
providing an indication of the second object or event to the user;
receiving a response from the user based on the indication; and
updating the custom class based on the response.

2. The method of claim 1, further comprising:
capturing images of the environment outside of a vehicle; and
receiving the text prompt from the user within the vehicle.

3. The method of claim 1, further comprising:
providing the indication by a text-to-speech system.

4. The method of claim 1, wherein the image-capturing device comprises at least one of:
an optical device adapted to capture optical images;
a lidar device adapted to capture lidar images;
an infrared device adapted to capture infrared images;
a radar device adapted to capture radar images; or
a sonar device adapted to capture sonar images.

5. The method of claim 1, further comprising:
providing the indication by highlighting the second object or event within a graphical display comprising at least one of:
an infotainment display in a vehicle;
a head-up display in a vehicle;
a display of a mobile device; or
a display of a head-worn device.

6. The method of claim 1, wherein:
the predefined threshold is configurable by the user.

7. The method of claim 1, further comprising:
receiving the response comprising a voice input captured by a microphone; and
processing the voice input using a natural language processing system to extract meaning from syntax or semantics or both.

8. The method of claim 1, further comprising:
receiving the response comprising a voice input captured by a microphone; and
processing the voice input using an emotion-recognition system to extract meaning from sentiment or prosody or both.

9. The method of claim 1, further comprising:
capturing the images of the environment outside of a vehicle;
receiving the text prompt from a user within the vehicle; and
receiving the response comprising a change in trajectory of the vehicle.

10. The method of claim 1, further comprising:
capturing the images of the environment outside of a vehicle;
receiving the text prompt from a user within the vehicle; and
receiving the response comprising a change in velocity of the vehicle.

11. The method of claim 1, further comprising:
receiving the response comprising shift in facial expression of the user determined by a facial analysis system.

12. The method of claim 1, further comprising:
detecting a gaze direction of the user using an eye-tracking system to identify an area of interest within the environment; and
prioritizing objects or events within the area of interest when computing the similarity scores.

13. The method of claim 1, further comprising:
detecting a gaze direction of the user using an eye-tracking system to identify an area of interest within the environment; and
adjusting a field of view of the image-capturing device based on the gaze direction to capture images of the environment to more closely align with the area of interest.

14. The method of claim 1, further comprising:
utilizing the updated custom class in real-time to enhance an accuracy of identifying objects or events in subsequent captured images.

15. The method of claim 1, further comprising:
incorporating additional captured images, additional text prompts from additional users, additional indications of additional second objects or events to the additional users, and additional responses from the additional users to collaboratively update the custom class.

16. The method of claim 1, further comprising:
storing the custom class in a remote database to enable access and use by multiple devices.

17. A system, comprising:
one or more memories; and
one or more processors configured to execute instructions stored in the one or more memories to:
capture images of an environment in real-time using an image-capturing device;
generate image embeddings of the captured images using a trained Contrastive Language-Image Pre-training (CLIP) model;
receive a text prompt from a user indicating a first object or event;
generate a text embedding of the text prompt using the CLIP model;
compute similarity scores between the text embedding and the image embeddings;
determine a highest similarity score of the similarity scores;
determine that the highest similarity score exceeds a predefined threshold;
in response to determining that the highest similarity score exceeds the predefined threshold:
identify, in the respective captured image that corresponds to the highest similarity score, a second object or event that correlates with the first object or event;
store the text prompt and the respective captured image as a custom class for future use by the CLIP model;
provide an indication of the second object or event to the user;
receive a response from the user based on the indication; and
update the custom class based on the response.

18. The system of claim 17, wherein the instructions include instructions to:
capture images of the environment outside of a vehicle; and
receive the text prompt from a user driving the vehicle.

19. A non-transitory computer-readable medium storing instructions operable to cause one or more processors to perform operations comprising:
capturing images of an environment in real-time using an image-capturing device;
generating image embeddings of the captured images using a trained Contrastive Language-Image Pre-training (CLIP) model;
receiving a text prompt from a user indicating a first object or event;
generating a text embedding of the text prompt using the CLIP model;
computing similarity scores between the text embedding and the image embeddings;
determining a highest similarity score of the similarity scores;
determining that the highest similarity score exceeds a predefined threshold;
in response to determining that the highest similarity score exceeds the predefined threshold:
identifying, in the respective captured image that corresponds to the highest similarity score, a second object or event that correlates with the first object or event;
storing the text prompt and the respective captured image as a custom class for future use by the CLIP model;
providing an indication of the second object or event to the user;
receiving a response from the user based on the indication; and
updating the custom class based on the response.

20. The medium of claim 19, the operations further comprising:
updating the custom class by determining a loss according to a loss function;
determining a gradient of the loss with respect to a parameter of the CLIP model; and
adjusting the parameter in a direction of the gradient that reduces the loss.
